(19) United States
(12) Patent Application Publication
(10) Pub. No.: US 2012/0068110 A1
(43) Pub. Date: Mar. 22, 2012

(54) Hydroxyl Compounds Carrying Reactive Silyl Groups And Used As Ceramic Binders

(75) Inventors: Frank Schubert, Neukirchen-Vluyn (DE); Thomas Ebbrecht, Wetter/Ruhr (DE); Matthias Naumann, Greensboro, NC (US); Wilfried Knott, Essen (DE)

(73) Assignee: EVONIK GOLDSCHMIDT GMBH, Essen (DE)

(21) Appl. No.: 13/322,477

(22) PCT Filed: Apr. 26, 2010
(86) PCT No.: PCT/EP2010/055508

§ 371 Date: Nov. 25, 2011

(30) Foreign Application Priority Data
May 25, 2009 (DE) 102009022627.3

(51) Int. Cl. C07F 7/02; C04B 35/10; C03C 14/00; C04B 35/56; C07F 7/18; C09K 3/00; C04B 35/515; C04B 35/52; C04B 35/01; C04B 35/58; C08K 5/5419; C04B 24/40; C04B 28/26; C04B 28/06; C04B 28/14; C04B 35/00; B82Y 30/00

(52) U.S. Cl. 252/182.3; 501/154; 501/153; 501/32; 501/87; 556/446; 556/444; 524/266; 252/183.11; 106/806; 106/634; 106/696; 106/724; 106/781; 977/902

(57) ABSTRACT

The application relates to a reactive ceramic binder suitable for producing ceramic products from ceramic powder, characterized in that the reactive ceramic binder represents hydroxyl compounds which carry reactive silyl groups and can be additionally (poly)siloxane-substituted.

Hydroxyl compounds which bear silyl groups and are used in the context of this invention are understood to mean all reaction products which can be prepared by alkoxylation of epoxy-functional silanes over double metal cyanide catalysts by the process described in document DE 10 2008 000360.3, which was yet to be published at the priority date of the present application; more particularly, these compounds may also bear siloxane groups. These compounds are referred to hereinafter as silyl polyethers 1. A silyl group in the context of this invention is characterized by different or identical organic or oxyorganic radicals.

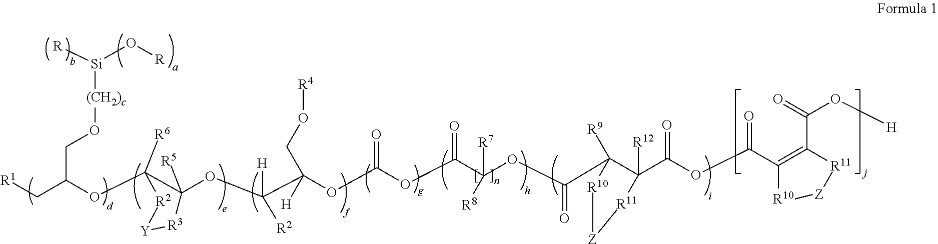

In the context of this invention, the term “polyethers” includes polyethers, polyetherols, polyether alcohols, polyether esters, but also polyether carbonates, which may be used synonymously with one another. It is not necessary that the expression “poly” must go hand in hand with a multitude of ether functions or alcohol functions in the molecule or polymer. Instead, this merely indicates that at least repeat units of individual monomers or else compositions which have a relatively high molar mass and additionally also a certain polydispersity are present.

The word fragment “poly” in the context of this invention does not encompass exclusively compounds having at least 3 repeat units of one or more monomers in the molecule, but especially also those compositions of compounds which have a molecular weight distribution and possess a mean molecular weight of at least 200 g/mol. This definition takes account of the fact that, in the field of industry in question, it is customary to define such compounds as polymers even if they do not appear to satisfy a polymer definition analogous to OECD or REACH guidelines.

The present invention provides a reactive binder suitable for the binding of ceramic particles for production of ceramic products, especially refractory ceramic products, from ceramic powder. The invention further provides for the use of the binder and a process for production of aforementioned ceramic products, and ceramic products as such, particular preference being given in accordance with the invention to refractory ceramic products.

Refractory ceramic products, also referred to hereinafter as “refractory materials”, are used for protection from high temperatures in numerous industrial plants. The most important refractory material types are:
shaped dense products having a porosity of ≦45% by volume, such as rocks and components,
shaped heat-insulating products with a porosity of ≧45% by volume, such as lightweight firebricks,
unshaped refractory products such as fire concretes, ramming compounds, spray compounds, tamping compounds and the like.

Conventional refractory products are produced from pulverulent raw materials. The particle size of the powders is within a relatively wide range, between a few micrometers and several millimeters. In isolated cases, raw materials with a particle size of >10 mm are also used. Correspondingly, the powders are referred to as coarse-grain, medium-grain, fine-grain and ultrafine-grain fractions.

In ceramics, binders have the task of influencing the cohesion of the components of the ceramic mixture. In plastic ceramic mixtures, they have the particular task of exerting influence on the green strength of the shaped ceramic mixture before the firing thereof.

Especially what are called “temporary” ceramic binders have the task of influencing the green strength. In the course of ceramic firing, the binder is essentially volatilized or oxidized. In some cases, components of the binder can also be incorporated into the ceramic body.

Temporary ceramic binders are used especially in ceramic processing and shaping processes such as spray granulation, in casting processes such as slip casting, pressure slip casting and film casting operations, in extrusion or in dry pressing operations.

The category of permanent binders includes the “chemical” ceramic binders, for example phosphates and silicates, which even after the firing of the ceramic mixture make a contribution to the cohesion of the components of the ceramic mixture.

In the ceramic industry, polymer-based binders are known, which are used in dissolved or dispersed form. Removal of the solvent or dispersion medium in the course of drying converts the polymer to a solid form. The mechanical properties of the polymer after the drying operation, of which the breaking strain, breaking strength and elasticity of the polymer in particular are of significance for the green body to be bonded, are determined by the chemical makeup and the structure of the polymers.

If these polymers are used in their particular form in ceramic slips, for example silicate, oxide or nonoxide ceramic slips, they are present in the structure of the green body after the processing or shaping and drying of the slip. The mechanical properties thereof are transferred to the green body to a certain degree and can thus, for example, increase the breaking strength or elasticity thereof.

Thus, the control of the mechanical properties of the polymers, for example by altering the chemical makeup thereof, can adjust the properties of the green body.

The prior art discloses the use of solid, branched or crosslinked, high molecular weight organomodified siloxanes or solid phenylmethylpolysiloxanes in ceramic products.

WO 93/01146 relates to a binder for thermoplastic molding compositions, comprising at least one thermoplastic silicone resin, having a softening temperature between 30° C. and 200° C., for the production of moldings from ceramic or metal from corresponding ceramic or metal powders. The uses of such thermoplastic molding compositions include those in processes such as injection molding, extrusion or hot pressing, in which temperature-dependent flow characteristics are needed. The silicone resins specified are, preferably in accordance with the invention, used without catalysts, such that there is no further crosslinking and curing during the shaping operation.

The use of these aforementioned solid siloxane compounds as ceramic binders has the disadvantage that very homogeneous mixtures with ceramic materials can be produced only inadequately, if at all. Moreover, use of such binders does not give sufficiently high green strength of the shaped ceramic product from ceramic particles without a thermal treatment at relatively high temperatures. A further disadvantage of the binders known in the prior art is that very high firing temperatures, typically of above 1000° C., are required to achieve refractory ceramic products with sufficient mechanical properties such as cold compressive strength. Furthermore, high pressures and long firing times are required, which is associated with a high level of energy expenditure.

WO 93/01146 further relates to a binder for thermoplastic molding compositions, the molding compositions being processed plastically exclusively above the softening temperature of the silicone resin, and being introduced under pressure into molds whose temperature is below the softening temperature of the silicone resin. Shaped ceramic products with a sufficient green strength cannot be produced according to the teaching of WO 93/01146 in the case of non-plastic processing, for example uniaxially, isostatically, with slip casting, by tamping, spraying, and especially at temperatures below the softening temperature of the silicone resin or the like. Moreover, it is not possible with the binder and process described in WO 93/01146 to produce unshaped ceramic products, especially refractory materials.

EP 1 852 405 describes reactive liquid ceramic binders which are suitable for production of ceramic products, said reactive liquid ceramic binder comprising organomodified siloxane compounds, said organomodified siloxane compounds containing organoalkoxysiloxane units of the following general formula 2:

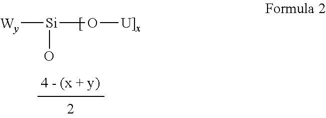

where
W is an alkyl radical and/or aryl radical,
U is H and/or an alkyl radical having 1 to 4 carbon atoms,
y is greater than or equal to 0 and less than or equal to 2 and
x is greater than 0 and less than or equal to 3,
   with the proviso that x+y is greater than or equal to 1 and less than or equal to 4.

The compounds described here can be prepared in various ways. Possible synthesis routes are described, for example, in EP 0 124 748 and the literature cited therein. However, the use of raw materials available on the industrial scale generally leads to products in which the organoalkoxysiloxane units are generally present at the chain ends of the siloxane backbone. The preparation of compounds in which several alkoxy functions are bonded to one siloxane unit is also costly and inconvenient. To optimize the product properties, it may, however, be advantageous to prepare products with particular siloxane topologies.

For example, the teaching of EP 1852405 in this respect states that ceramic products, especially refractory ceramic products, can be provided even at low treatment temperatures, and have an unexpectedly high cold compressive strength, by using reactive liquid ceramic binders, said reactive liquid ceramic binder comprising organomodified siloxane compounds, and said organomodified siloxane compounds having organoalkoxy-siloxane units of the general formula 3

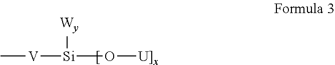

in which
W is independently identical or different alkyl, alkaryl or aryl radicals which are optionally interrupted by ether functions, preferably methyl or phenyl, especially methyl,
U is independently identical or different radicals from the group of H and/or alkyl radical having 1 to 6 carbon atoms, preferably methyl or ethyl,
V is independently identical or different divalent, optionally unsaturated hydrocarbon radicals having 1 to 30 carbon atoms, which is optionally interrupted by ether functions, preferably —(CH₂)ₙ— where n=1 to 11, especially —CH₂—CH₂—,
y is greater than or equal to 0 and less than or equal to 2.5 and
x is greater than 0 and less than or equal to 3,
   with the proviso that x+y is greater than or equal to 1 and less than or equal to 3.

Such organomodified siloxane compounds can be prepared, for example, by the hydrosilylation of alkoxy-functional vinylsilanes with SiH-functional siloxanes. In this way, it is possible to achieve a wide variety of different siloxane topologies in a simple manner, since a wide variety of different SiH-functional siloxanes are available. In addition, it is possible in a simple manner, by cohydrosilylation, to bond further organic radicals to the siloxane structure, for example in order to hydrophobize or hydrophilize the product in a controlled manner.

Astonishingly, it has now been found that polyols having alkoxysilyl groups, as described in application DE 10 2008 000360.3, which was yet to be published at the priority date of the present application, and/or organomodified polyethersiloxane compounds, are preferentially suitable as binders for production of ceramic products, especially refractory ceramic products. Very particularly surprisingly and advantageously, it has been found that hydroxyl compounds bearing silyl groups, also called alkoxysilyl-functional silicone polyethers or alkoxysilyl-functional polyether-siloxane copolymers, as described in DE 10 2008 044373.5, which was yet to be published at the priority date of the present application, can be used as ceramic binders as binders. This novel class of compounds combines the advantages of the alkoxysilyl polyethers according to DE 10 2008 000360.3 with those of polysiloxane compounds used to date according to the prior art in one molecule. The reactive alkoxysilyl groups of the copolymers permit good curing during the shaping process even at relatively low temperatures and lead to green bodies with increased mechanical strength, while the siloxane moiety of the copolymers releases, at relatively high temperatures in the subsequent firing operation, additional SiO₂ which imparts the high cold compressive strength required to the refractory end products. The mass ratio of the siloxane moiety to the organic moiety of the alkoxysilyl-functional silicone polyethers and the alkoxysilyl functionality can be adjusted virtually as desired and enable exceptionally flexible adjustment of the chemical composition to the particular technical requirements of the processing operation to give high-stability refractory ceramics. The organomodification of the siloxane body to give polyether siloxanes bearing alkoxysilyl groups allows the preparation of homogeneous mixtures comprising ceramic materials. By virtue of the compounds preferably being liquid, they thus additionally overcome the disadvantage of typically solid silicone resins as ceramic binder.

The term “ceramic product” encompasses, inter alia, ceramic compositions, dimensionally stable ceramic bodies and refractory ceramic products.

These novel hydroxyl compounds bearing silyl groups of the formula 1, which may have both alkoxysilane functions within the sequence of the oxyalkylene units of the polyether chain and novel alkoxysilane functions in the termini thereof, allow the anchor group density in the desired prepolymer to be adjusted as desired, i.e. matched to the particular application objective. These polyether structures may also be attached to linear or branched polysiloxane bodies via an SiC or SiOC bond, as described in DE 10 2008 044373.5.

These novel reactive polyethers and/or polyether siloxanes are curable polymers due to their hydrolysis-sensitive alkoxysilyl groups which tend to crosslink. The crosslinking thereof to give solid thermoset end products or the chemical attachment thereof to reactive surfaces, for example to particle surfaces, is effected in a simple manner, optionally with addition of water, acid or base as an accelerator, and the curing time can be controlled during the curing operation by increasing the temperature. Thus, the polymer structure of these crosslinkable polyethers and polyether siloxanes, according to the type of initiator and siloxane body and according to the type, amount and sequence of the epoxide monomers usable, can be varied in various ways, in order in this way to tailor important product properties of the application depending on the particular end use. For example, by a variation in the proportion of alkoxysilane units in the polymer chain, it is possible to influence the crosslinking density and hence the mechanical and physicochemical profile of properties of the cured systems within wide limits. Surprisingly, even polyethers and polyether siloxanes equipped with notable alkoxysilyl functionalization density here are liquids which have low viscosity at room temperature and standard pressure, are easy to handle and have viscosities of typically below 1000 mPas, and so there are no restrictions whatsoever with regard to the dosage of this component. This observation differentiates the inventive teaching from the procedure detailed in WO 2008/058955, which emphasizes the introduction of free silane monomers as formulation constituents in the final formulations in order to ensure that the necessary crosslinking density is achieved with simultaneously low processing viscosity. The polyethers having alkoxysilyl groups, the structural variety of which is virtually unlimited, and the siloxane copolymers thereof, give the person skilled in the art conversant in polymer chemistry, through the introduction, for example, of ester, carbonate and aromatic structural elements into the polyether structure, a degree of configuration freedom which addresses virtually any application requirements. Even greater is the variety of possible alkoxysilyl polyether-siloxane copolymer structures, since any organic radical is bonded singly or multiply, terminally or laterally, to a polysiloxane structure which is linear or has different degrees of branching, is variable in its molar mass and is optionally additionally modified by other carbon radicals, the chemical linkage of the organic polyether component being either via an SiC or an SiOC bond. Equally, any desired mixtures of alkoxysilyl polyethers with silicone polyethers bearing alkoxysilyl groups are usable.

The hydroxyl compounds of the formula 1 which bear silyl groups and are obtained by processes mentioned are outstandingly suitable as reactive crosslinkers and binders for various substrates, for example inorganic ceramic powders.

The invention therefore provides curable silyl polyethers of the formula 1 as a constituent of compositions usable as binders for ceramic materials.

As known to those skilled in the art, the crosslinking or curing of alkoxysilyl groups is accomplished in a two-stage chemical process, in which, in a first step, the alkoxy groups bonded to the silicon are eliminated as corresponding alcohols and SiOH groups are formed in the presence of water, though atmospheric humidity may also be sufficient. In the case of self-condensation, these SiOH groups then condense with one another to form Si—O—Si bridges and form polymeric materials. Alternatively, the SiOH functional intermediates react with substrates having reactive groups, for example particularly efficiently with oxidic and/or silicatic surfaces bearing OH functions (for example mullite, alumina or else magnesia), and lead to excellent chemical anchoring on the particular substrate. The curing rate can be influenced in various ways, by addition of catalysts or temperature variations.

Preference is given to the use of curable silyl polyethers 1 with at least one non-terminal silyl function, preferably more than one non-terminal and more preferably more than one non-terminal and at the same time at least one terminal silyl function in the molecule, and they especially contain more than one (1) alkoxysilyl function per chain end reactive toward epoxide groups, very particular preference being given to those having an average of more than one silyl group per terminal hydroxyl group in compositions usable as ceramic binders.

The polyether siloxanes of DE 10 2008 044373.5 used with preference bear at least one alkoxysilyl group in the copolymer structure.

The alkoxysilyl-modified polyethers of the formula (1) usable in accordance with the invention can be obtained by the alkoxylation of silyl-modified epoxides and a starter alcohol from a wide variety of different origins.

The preparation and the usable epoxide structure types are described in detail in European patent application EP 09152883.6, which was yet to be published at the priority date of the present application. The content of the description and of the claims of EP 09152883.6 and of the corresponding priority application DE 10 2008 00360.3, which was yet to be published at the priority date of the present application, is hereby incorporated in full into this disclosure.

The silyl polyethers 1 give the synthetic freedom to select between polyoxyalkylene compounds having alkoxysilyl groups, which contain the alkoxysilyl functions crosslinkable with hydrolysis in terminal form, or else in isolated form, in blocklike cumulated form, or else scattered randomly in the polyoxyalkylene chain. Such silyl polyethers 1 of the formula (1) are notable in that they can be prepared in a controlled and reproducible manner with regard to structure and molar mass. The sequence of the monomer units can be varied within wide limits. Epoxide monomers may, as desired, be arranged successively in blocks or incorporated randomly into the polymer chain. The fragments inserted into the polymer chain which forms by the reaction with ring opening of the reaction components are freely permutable with one another in the sequence thereof, with the restriction that cyclic anhydrides and carbon dioxide are present randomly inserted, i.e. not in homologous blocks, in the polyether structure.

If the silyl polyethers 1 used are those which contain more than one of the highly functionalized polyalkylene ether fragments bonded to the silicon atom, highly functionalized compounds are present, in which polyether chains each derived from a starter alcohol of the formula R¹—H (4) and each containing the fragments which are freely permutable in the sequence thereof, which have been inserted into the polymer chain which forms by the reaction with ring-opening of the reaction components, are joined to one another via —CH₂—O—(CH₂)_{c}—Si—(CH₂)_{c}—O—CH₂— bridges. These are highly complex, highly functionalized structures. Here too, it is possible to adjust the functionalities in a controlled manner to a desired field of use. The degree of branching and the complexity of the resulting polymer structures rise with increasing epoxy functionality of the silyl monomers. The chain length of the polyether radicals which have alkoxy, arylalkoxy or alkylarylalkoxy groups and are usable as a starter compound is as desired. Preferably, the polyether, alkoxy, arylalkoxy or alkylarylalkoxy group contains 1 to 1500 carbon atoms, more preferably 2 to 300 carbon atoms, especially 2 to 100 carbon atoms. The OH-functional starter compounds R¹—H (4) used are preferably compounds having molar masses of 18 to 10 000 g/mol, especially 50 to 2000 g/mol, and having 1 to 8, preferably 1 to 4, hydroxyl groups. If, however, a siloxane moiety is to be introduced into the silyl polyether as R¹, for example, α,ω-dihydroxy-polysiloxanes, hydrogen siloxanes or hydroxyl-functional polyether siloxanes are used as starting compounds.

The fragments which have been inserted into the polymer chain which forms by the reaction with ring-opening may be distributed blockwise or randomly within the above definitions, and occur not only in the chain of a polyether structural unit, but also occur in random distribution over the multitude of polyether structural units formed, which are joined to one another via —CH₂—O— (CH₂)_{c}—Si—(CH₂)_{c}—O—CH₂— bridges. The diversity of the structural variations of the process products thus does not permit a clear description in the manner of a formula. Very particular preference is given to 3-glycidyloxyalkyltrialkoxysilanes and 3-glycidyloxy-alkyldialkoxyalkylsilanes as monomers.

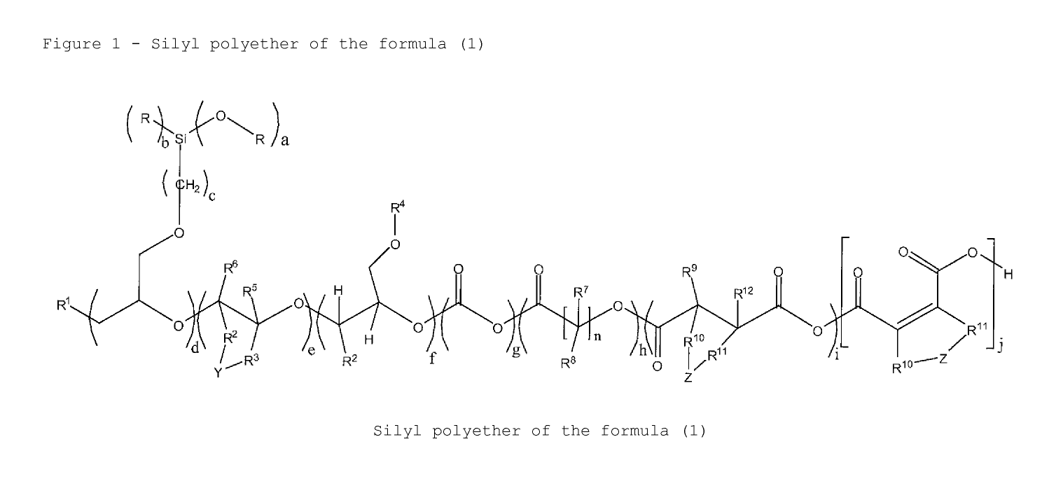

Preferably, the binders used are silyl polyethers 1 of the formula (1)—see also FIG. 1. These consist of chains substituted by alkoxysilyl groups, which are highly functionalized in a controlled manner by virtue of the selection of the fragments d to j, in accordance with the fragments inserted into the polymer chain by the reaction with ring-opening of the reaction components, and hence can be tailored for various fields of use.

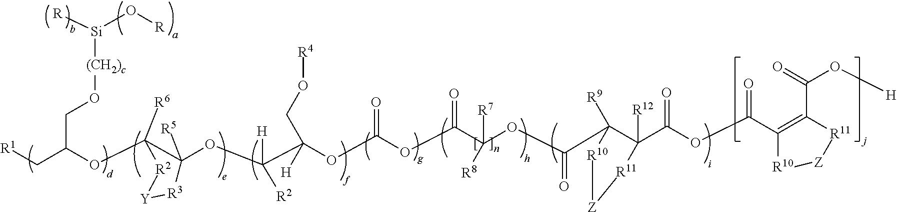

Silyl polyether of the formula (1) (see also FIG. 1)

where
a is an integer from 1 to 3, preferably 3,
b is an integer from 0 to 2, preferably 0 to 1, more preferably 0,
   and the sum of a and b is equal to 3,
c is an integer from 0 to 22, preferably from 0 to 6, more preferably 1 or 3,
d is an integer from greater than 1 to 1000, preferably greater than 1 up to 100, more preferably greater than 1 up to 20 and especially greater than 1 up to 10, or greater than 10 up to 100,
e is an integer from 0 to 10 000, preferably 0 to 1000, more preferably 0 to 300 and especially 0 to 100,
f is an integer from 0 to 1000, preferably 0 to 100, more preferably 0 to 50 and especially 0 to 30,
g is an integer from 0 to 1000, preferably 0 to 200, more preferably 0 to 100 and especially 0 to 70,
h, i and j are each integers from 0 to 500, preferably 0 to 300, more preferably 0 to 200 and especially 0 to 100,
   and with the proviso that the fragments with the indices d to j are freely permutable with one another, i.e. are exchangeable for one another in the sequence within the polyether chain,
n is an integer from 2 to 8 and
R represents one or more identical or different radicals selected from linear or branched, saturated or mono- or polyunsaturated alkyl radicals having 1 to 20, especially 1 to 6, carbon atoms or haloalkyl groups having 1 to 20 carbon atoms. Preferably, R is methyl, ethyl, propyl, isopropyl, n-butyl and sec-butyl groups, and especially ethyl or methyl groups,
   where
R¹ is a saturated or unsaturated, optionally branched radical preferably attached via an oxygen atom, or a polyether radical of the alkoxy, arylalkoxy or alkylarylalkoxy group type in which the carbon chain may be interrupted by oxygen atoms, or R¹ is an optionally singly or multiply fused aromatic aryloxy group, or a silicon compound, especially a siloxane radical which may be substituted by alkyl and/or aryl groups and/or polyether.
R² and R³, and R⁵ and R⁶, are the same, or else are each independently, H or a saturated or optionally mono- or polyunsaturated, also further-substituted, optionally mono- or polyvalent hydrocarbon radical, it being the case the R⁵ and R⁶ radicals are each a monovalent hydrocarbon radical.
   The hydrocarbon radical might be bridged cycloaliphatically via the Y fragment; Y may be absent, or else may be a methylene bridge having 1 or 2 methylene units; if Y is absent, R² and R³ are each independently a linear or branched radical having 1 to 20, preferably 1 to 10, carbon atoms, more preferably a methyl, ethyl, propyl or butyl, vinyl, allyl or phenyl radical. Preferably, at least one of the two R² and R³ radicals is hydrogen. R²-R³ may be a —CH₂CH₂CH₂CH₂— group, and Y may thus be a —(CH₂CH₂—)— group. The hydrocarbon radicals R² and R³ may in turn have further substitution and bear functional groups such as halogens, hydroxyl groups or glycidyloxypropyl groups.
R⁴ is a linear or branched alkyl radical of 1 to 24 carbon atoms or an aromatic or cycloaliphatic radical which may optionally in turn bear alkyl groups.
R⁷ and R⁸ are each independently hydrogen, alkyl, alkoxy, aryl or aralkyl groups which are copolymerized with ring-opening polymerization to give crosslinkable polyether esters containing alkoxysilane groups.
R⁹, R¹⁰, R¹¹ and R¹² are each independently hydrogen, alkyl, alkenyl, alkoxy, aryl or aralkyl groups. The hydrocarbon radical may be bridged cycloaliphatically or aromatically via the Z fragment, and Z may be either a divalent alkylene or alkenylene radical.

It may be advantageous when the silyl polyethers of the formula (1) are those which have exclusively R¹ radicals which contain silicon atoms, or those which have exclusively R¹ radicals which do not have any silicon atoms.

The different monomer units, both of the fragments with the indices d to j and of any polyoxyalkylene chain present in the R¹ substituent, may have a blockwise structure with respect to one another or else be subject to a random distribution. The indices reproduced in the formulae shown here, and the value ranges of the indices specified, are therefore the mean values of the possible random distribution of the structures actually present and/or mixtures thereof. This also applies to structural formulae reproduced exactly per se as such, as, for example, for formula (1).

Very particular preference is given to 3-glycidyloxy-alkyltrialkoxysilanes and 3-glycidyloxyalkyldialkoxy-alkylsilanes as monomers.

As ²⁹Si NMR and GPC analyses show, the process-related presence of chain-terminal OH groups results in the option of transesterification reactions on the silicon atom, both during the DMC-catalyzed preparation and, for example, in a downstream process step. In a formal sense, the alkyl radical R bonded to the silicon via an oxygen atom is exchanged for a long-chain modified alkoxysilyl polymer radical. Bimodal and also multimodal GPC curves show that the alkoxylation products contain not only the non-transesterified species as reproduced in formula (1) but also those with twice, in some cases three times or even four times the molar mass. Formula (1) therefore reproduces the complex chemical reality only in simplified form.

Thus, the compositions also comprise compounds in which the sum of the indices (a) plus (b) in formula (1) has a statistical average of less than 3, since some of the OR groups can be replaced with silyl polyether groups. The compositions thus contain species which are formed at the silicon atom with elimination of R—OH and condensation reaction with the reactive OH group of a further molecule of the formula (1). This reaction can proceed several times until, for example, all RO groups on the silicon have been exchanged for further molecules of the formula (1). The presence of more than one signal in typical ²⁹Si NMR spectra of these compounds supports the presence of silyl groups with different substitution patterns. The values and preferred ranges reported for the indices a to j should thus also be understood merely as average values over the different species which cannot be considered individually.

The R¹ group originates either from a starter alcohol R¹—H (4) (the H belongs to the OH group of the OH-containing compound used as the starter, referred to here as starter alcohol) which is used in the DMC-catalyzed alkoxylation; examples of compounds of the formula (4) include allyl alcohol, butanol, octanol, dodecanol, stearyl alcohol, 2-ethylhexanol, cyclohexanol, benzyl alcohol, ethylene glycol, propylene glycol, di-, tri- and polyethylene glycol, 1,2-propylene glycol, di- and polypropylene glycol, 1,4-butanediol, 1,6-hexanediol, trimethylolpropane, glycerol, pentaerythritol, sorbitol, cellulose sugar, lignin, or else further compounds which bear hydroxyl groups and are based on natural substances.

If, however, a siloxane moiety is to be introduced as R¹ into the silyl polyether, for example, α,ω-dihydroxypolysiloxanes, hydrogen siloxanes or hydroxyl-functional polyether siloxanes are used as starting compounds.

Very particularly suitable binders for production of refractory ceramics are the polyether siloxanes which bear alkoxysilane units and are described in document DE 10 2008 044373.5, which was yet to be published at the priority date of the present application. The content of the description and of the claims is hereby incorporated into this disclosure in full.

If a (poly)siloxane radical is thus introduced into the molecule as R¹, alkoxysilyl-functional polyether siloxanes are used in accordance with the invention.

These alkoxysilyl-functional polyether siloxanes and mixtures thereof can be prepared by two different processes, as described in DE 10 2008 0044373.5:
1) alkoxylation of silicone polyether copolymers or polysiloxanes with epoxy-functional alkoxysilanes over double metal cyanide catalysts and/or
2) hydrosilylating linkage of polyethers bearing unsaturated alkoxysilyl groups, which have been obtained beforehand by an alkoxylation of the corresponding unsaturated starter compounds with epoxy-functional alkoxysilanes over DMC catalysts.

The alkoxysilyl-functional polyether siloxanes are compounds of the formula (5) and mixtures thereof

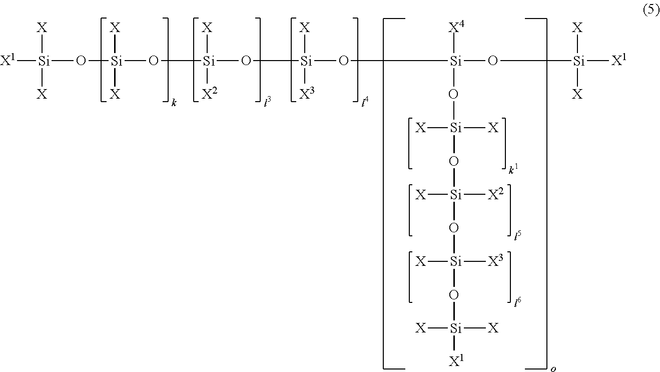

where
   X is a linear, cyclic or branched, aliphatic or aromatic, saturated or unsaturated hydrocarbon radical which has 1 to 20 carbon atoms and may optionally contain heteroatoms such as oxygen, nitrogen, phosphorus or sulfur, but which is preferably a methyl group,

### X¹ may be X, X² or X³,

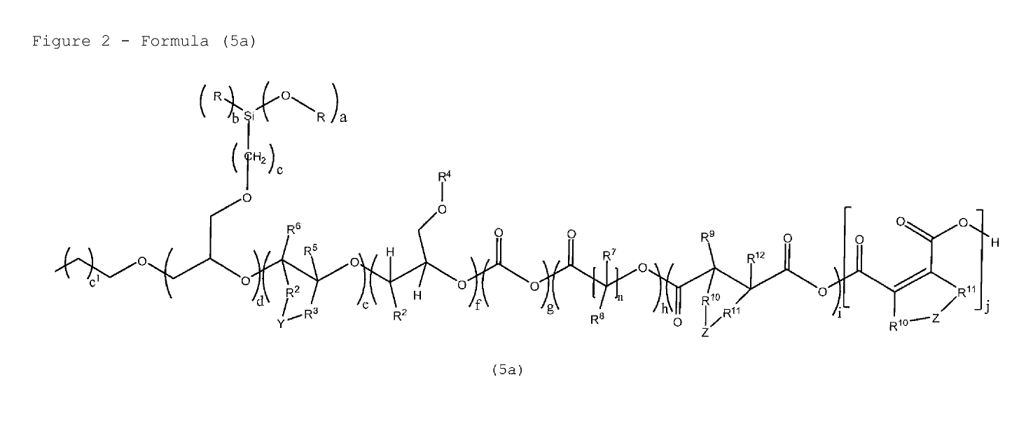

X² is an OH-functional, optionally ester- or carbonate-modified polyoxyalkylene radical which bears alkoxysilyl groups and is of the formula (5a)—see also FIG. 2—,

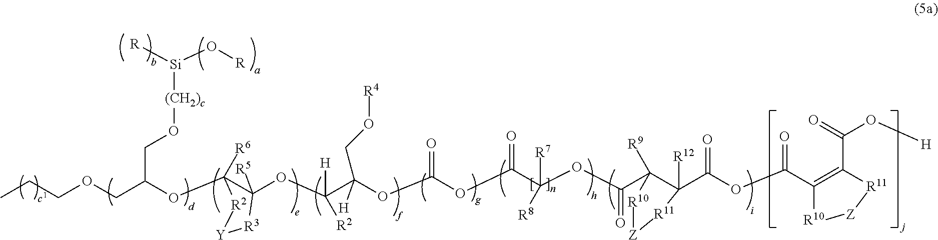

—see also FIG. 2
   X³ is a terminally etherified polyoxyalkylene radical of the formula (5b)

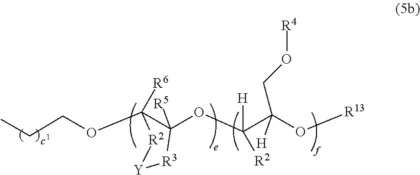

where
R¹³ is either an alkyl group having 1 to 18 carbon atoms, preferably methyl, or a polyoxyalkylene radical which has been terminally esterified with a monofunctional carboxylic acid and is of the formula (5c)

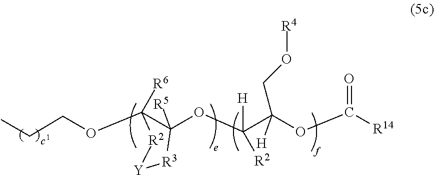

where
R¹⁴ is a saturated or a mono- or polyunsaturated, either linear or branched, aliphatic or aromatic hydrocarbon radical which has 1 to 30 carbon atoms and may in turn bear OH groups, preferably a methyl radical
X⁴ is either X¹ or the fragment of the formula (5d)

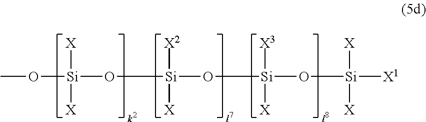

where
k, k¹ and K² are each independently integers from 0 to 500, preferably from 10 to 200, especially 15 to 100,
l³, l⁴, l⁵, l⁶, l⁷ and l⁸ are each independently integers from 0 to 60, preferably from 0 to 30, especially from 0 to 25,
o is an integer from 0 to 10, preferably from 0 to 3,
   with the proviso that
X¹ is at least once the same as X² if the sum of l³, l⁵ and l⁷ is zero,
and that the sum of l³, l⁵ and l⁷ is at least 1 when X′ is different than X²,
   where
a is an integer from 1 to 3, preferably 3,
b is an integer from 0 to 2, preferably 0 to 1, more preferably 0,
   the sum of a and b is equal to 3,
c is an integer from 0 to 22, preferably from 0 to 6, more preferably 1 or 3,
c¹ is an integer from 0 to 24, preferably from 0 to 12, more preferably from 0 to 8, even more preferably from 0 to 4, especially 1,
d is an integer from 1 to 1000, preferably greater than 1 up to 100, more preferably greater than 1 up to 20 and especially greater than 1 up to 10, or greater than 10 up to 100,
e is an integer from 0 to 10 000, preferably 0 to 1000, more preferably 0 to 300 and especially 0 to 100,
n is an integer from 2 to 8 and
f, g, h, i and j are each integers from 0 to 500, preferably 0 to 300, more preferably 0 to 200, especially 0 to 100,
   with the proviso that the fragments with the indices d to j are freely permutable with one another, i.e. are exchangeable for one another in the sequence within the polyether chain, and where the different monomer units of the fragments with the indices d to j may each have blockwise structure with respect to one another or else may be subject to a random distribution, and with the proviso that the fragments with the indices k, k′, k², l³, l⁴, l⁵, l⁶, l⁷, l⁸ and o are freely permutable with one another, i.e. are exchangeable for one another within the siloxane chain and may either be distributed randomly or arranged successively in blocks.
R represents one or more identical or different radicals selected from linear or branched, saturated or mono- or polyunsaturated alkyl radicals having 1 to 20, especially 1 to 6, carbon atoms or haloalkyl groups having 1 to 20 carbon atoms, preferably a methyl, ethyl, propyl, isopropyl, n-butyl or sec-butyl group.
R² and R³, and R⁵ and R⁶, are the same, or else are each independently, H or a saturated or optionally mono- or polyunsaturated, also further-substituted, optionally mono- or polyvalent hydrocarbon radical, it being the case the R⁵ and R⁶ radicals are each a monovalent hydrocarbon radical.
   The hydrocarbon radical might be bridged cycloaliphatically via the Y fragment; Y may be absent, or else may be a methylene bridge having 1 or 2 methylene units; if Y is 0, R² and R³ are each independently a linear or branched radical having 1 to 20, preferably 1 to 10, carbon atoms, more preferably a methyl, ethyl, propyl or butyl, vinyl, allyl radical or phenyl radical. Preferably, at least one of the two radicals in R² or R³ is hydrogen. The hydrocarbon radicals R² and R³ may in turn have further substitution and bear functional groups such as halogens, hydroxyl groups or glycidyloxypropyl groups.
R⁴ is a linear or branched alkyl radical of 1 to 18 carbon atoms, which may be bonded to an aromatic or cycloaliphatic radical.
R⁷ and R⁸ are each independently hydrogen, alkyl, alkoxy, aryl or aralkyl groups.
R⁹, R¹⁰, R¹¹ and R¹² are each independently hydrogen, alkyl, alkenyl, alkoxy, aryl or aralkyl groups, where the hydrocarbon radical may be bridged cycloaliphatically or aromatically via the Z fragment, and Z may be either a divalent alkylene or alkenylene radical.

The polyether siloxanes described by formula (5) include the by-products which may be present as a result of the process, such as free excess polyethers or rearrangement products, and are notable in that the high silicon content of the molecules can serve as an additional SiO₂ source in the firing process and can thus give rise to an improved strength of the basic ceramic body. The basic ceramic body is often also referred to in the literature as a green, brown or white body, according to whether the usually organic binder has already been partly or fully degraded by temperature-dependent drying operations (above the decomposition temperature of the organic binder).

The different monomer units within the siloxane chain or within the polyether chain joined thereto may either have a blockwise or random structure with respect to one another. The indices reproduced in the formulae shown here and the value ranges of the indices specified are the mean values of the possible random distribution of the actual isolated structures and/or mixtures thereof. This also applies to structural formulae reproduced exactly per se as such.

The polyether siloxanes with alkoxysilyl functionalization of the formula (5) are usually copolymers with comb-type branching, in which the polyether chains are each bonded to the polysiloxane base structure via SiC bonds.

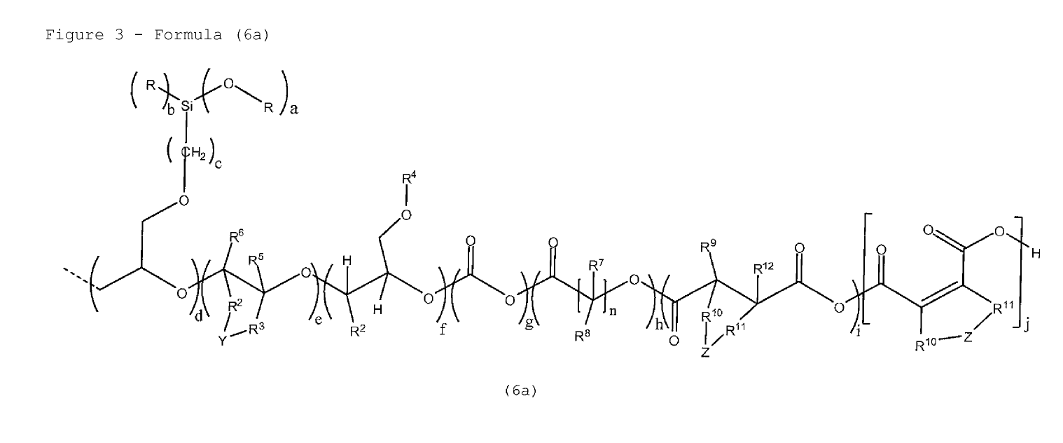

It is likewise possible in accordance with the invention to use linear polyether-siloxane-polyether triblock copolymers of the formula (6), in which the polyether chains equipped with alkoxysilyl groups are bonded to the siloxane body via an Si—O—C linkage, for example obtained from dehydrogenating coupling reactions,

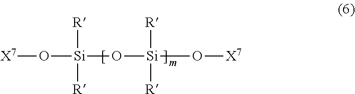

where
R′ is one or more identical or different, linear or branched, saturated or mono- or polyunsaturated alkyl radicals having 1 to 20 carbon atoms, especially 1 to 10 carbon atoms, and
m is an integer from 0 to 5000, preferably 2 to 5000, more preferably from 5 to 4000 and especially 9 to 3000, and
X⁷ is the polyether fragment of the formula (6a)—see also FIG. 3.

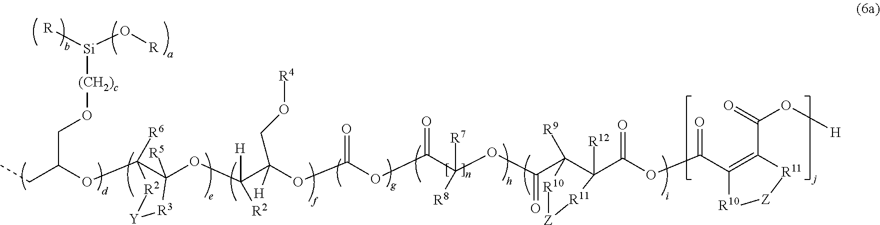

—see also FIG. 3

The substituents R, R²−R¹², the Y and Z radicals and the indices a, b, c, d, e, f, g, h, i, j and n are each as defined above for the compounds of the formula (5a).

The indices reproduced in the formulae (5) to (5d) and (6) and (6a), and the value ranges of the indices specified, are the mean values of the possible random distribution of the actual structures present and/or mixtures thereof.

The alkoxysilane polymers of the formulae (1), or the structures containing siloxane groups of the formulae (5) and (6), can be used alone or in any combination, blended with monomeric alkoxysilanes, alkoxysilyl-terminated prepolymers, alkoxysilyl-modified siloxanes, as can be obtained, for example, by hydrosilylation of hydrogen siloxanes with vinyl-substituted alkoxysilanes, silicone resins, curing catalysts and further additional components and auxiliaries, which add up to 100 parts.

The aforementioned silane polymers usable in accordance with the invention can, due to their low viscosity, also be used as reactive diluents in combination with other silyl compounds, which are then typically of relatively high viscosity. Prepolymers which have high alkoxysilyl functionality and are of the formula (1) increase the network density, ensure the required good chemical attachment to the inorganic substrates and ultimately lead to high-stability ceramic refractory products. The use of siloxane-bonded alkoxysilane compounds of the formulae (5) and/or (6) individually or in a mixture with compounds of the formula (1) brings about a further improvement in the mechanical properties of refractory materials produced therewith, since the siloxane structure of the copolymers during the firing process functions as an additional silicon dioxide source and increases the strength of the ceramic bodies once again.

In addition to the compounds (1) which have alkoxysilyl groups and are usable in accordance with the invention, it is also possible to add to the ceramic binders further organomodified binders capable of hydrolytic reactive crosslinking, especially those which bear organoalkoxysiloxane units and are not necessarily described by the above formula.

In addition, the inventive reactive ceramic binder may be liquid or comprise a solvent selected from the group comprising organic solvents, preferably liquid hydrocarbons, especially having a boiling point between 40° C. and 100° C., for example alcohol and/or acetone and mixtures thereof. The addition of solvents can, for example, improve the miscibility with ceramic powder.

It may be preferable that the reactive ceramic binder, especially a ceramic binder comprising alkoxysilane compounds of the formulae (1), or the structures (5) or (6) containing siloxane groups, is used in a mixture with water, more preferably as an aqueous emulsion. The use of an aqueous emulsion in combination with the ceramic powder can produce, for example, a material which is already capable of being cast or sprayed at room temperature.

To improve the properties, for example in relation to processability, handling, drying operation, firing operation, strength, corrosion stability and/or oxidation stability, of the ceramic composition and/or ceramic product, at least one additive can be added to the ceramic binder, this additive being different from the alkoxysilane compounds used in accordance with the invention and being selected from the group comprising an inorganic binder, an organic or siloxane compound bearing alkoxysilyl groups as described in EP 1852405, inorganic salts of each of sulfuric acid and/or hydrochloric acid and/or phosphoric acid, magnesium chloride, magnesium sulfate, monoaluminum phosphate, alkali metal phosphate, alkali metal silicate, waterglass, an organic binder, cellulose derivative, polyvinyl alcohol, water, organic solvents, mold release agents, stabilizers, organic pigments, inorganic pigments, nonoxidic substances, preferably carbon, preferentially in the form of carbon blacks, graphites or graphitized carbon materials, metal powders, metal fibers, ceramic fibers, glass fibers, natural fibers, synthetic fibers, metal oxides, metal hydroxides, for example aluminum trihydroxide or magnesium dihydroxide, borides, carbides, nitrides, oxynitrides, oxycarbides, silicides, polymers, catalysts and/or carbon fibers. Preference may be given to the addition of very reactive nanoscale and/or nanostructured, oxidic and/or nonoxidic powders, and particular preference may be given to the addition of nanoscale or nanostructured metal oxides such as nano-alumina and/or of precursors thereof; these include, for example, AEROXIDE® Alu C from Evonik Degussa GmbH.

Further additives such as functional additives, which are usable in accordance with the invention particularly for improving processability, handling, green density and strength, etc. include setting retarders, setting accelerators, pressing aids, lubricants, standardizers, defoamers, liquefiers, sintering agents, spreading agents, and the like.

Particular preference is given to the use of polymers of the inventive binder which have alkoxysilyl groups in combination with further additives, such as organic and/or inorganic binders, water, organic solvents, functional additional components such as carbon, preferably in the form of carbon blacks, graphites or graphitized carbon materials, borides, metal powders, carbides, silicides, oxides, metal hydroxides, for example aluminum trihydroxide or magnesium dihydroxide, and the like.

It may likewise be advantageous to use ceramic binders in combination with hydraulic binders, such as hydrated alumina (known as rho-alumina), calcium aluminate cement, portland cement, gypsum, optionally with water in variable amounts.

It is possible with preference to add nanoscale metal oxides, preferably nanoscale alumina, to the ceramic binder, which can lead to an improved cold compressive strength of ceramic products.

Refractory ceramic products are also referred to in general and in the description of the present invention as refractory ceramic materials or refractory materials.

It is a further advantage of the present invention that ceramic products can be produced with a sufficient green strength by use of the inventive reactive ceramic binder at temperatures of <30° C., preferably at room temperature. This becomes possible through the availability and the use of poly-alkoxysilyl-functional and simultaneously low-viscosity alkoxysilyl polyethers, the high reactivity and anchor group density of which in the molecule leads to a high green strength in the first phase of the firing process even at <200° C. Very particular preference is given to the use of alkoxysilane-functional polyether-siloxane copolymers and mixtures thereof with alkoxysilane-functional polyethers, since the minimum strength known to those skilled in the art, which lies at 300-900° C. later in the firing operation and is due to the thermal/oxidative decomposition of the organic binder component, can be compensated for by the increased release of silicon dioxide from the siloxane body of the copolymers of the formulae (5) and (6). The binders which comprise silicone copolymers (5) and (6) and are usable in accordance with the invention thus combine the individual advantages of both components.

The low viscosity of the binders first of all permits, in a simple manner, complete homogeneous coating of all ceramic particles in the preparation phase, and is the basis for subsequent achievement of high crosslinking densities and hence basic mechanical strengths as early as at the green body stage, or at already higher temperatures in brown body or even white body production.

As reference tests 1 to 3 (appendix) demonstrate, conventional silyl-terminated polymers as used particularly in conventional sealant and adhesive applications are entirely unsuitable for such ceramic binder applications, since they have an insufficient number of reactive, crosslinkable alkoxysilyl functions, and these are also attached only terminally to a high molecular weight polymer structure, usually polypropylene glycol, with typical molar masses of 8000-15 000 g/mol.

It is advantageous that the use of the inventive ceramic binders can lower the firing temperature and/or the firing time and hence the energy demand in the production of ceramic products, especially refractory products. Moreover, in the case of use of fossil energy carriers, as a result of the lower energy demand, CO₂ and NOₓ emissions can be reduced. It is often even more advantageous in economic terms that the service life of the kilns is prolonged due to the reduced firing times and/or reduced firing temperatures.

It has also been observed that the firing times, at least in most cases, can be shortened without any disadvantage with regard to the material properties, especially the strength of the ceramic products produced using the inventive ceramic binders, compared to conventional refractory ceramic products, i.e. those produced according to the prior art.

In addition, it has also been observed that, in the case of use of the inventive reactive ceramic binder within the temperature range between, for example, 100° C. and 1000° C., preferably 200° C. and 800° C., there is no or at worst only a slight decline in the material strength (compared to the green body treated at lower temperatures), i.e. cold compressive strength [MPa], when they comprise alkoxysilyl-functional polyether siloxanes of the formula (5) and/or (6).

It is another advantage of the inventive reactive ceramic binder that it imparts a high dimensional stability to the ceramic product with or without addition of water, and is therefore also usable with preference for ceramic products prone to hydration, for example basic refractory materials.

Ceramic products in the context of this invention also include dried, heat-treated and/or fired ceramic products. The term “ceramic product” as used in the present description also includes what are called green bodies. More particularly, the term “ceramic product” includes heat-resistant and/or refractory ceramic products (refractory materials). In addition, a ceramic product is also understood to mean products, such as moldings and materials, which comprise what is called a composite material, i.e. which are formed from a ceramic material and at least one other material or another phase. These may also be present as at least one ceramic layer, preferably a ceramic surface coating.

By means of the inventive reactive ceramic binder, it is possible to obtain shaped and unshaped ceramic products, especially heat-resistant and/or refractory, unfired and/or fired ceramic moldings, unshaped refractory products, for example concretes, ramming compounds, casting compounds, coatings or overcoats with excellent physical and mechanical properties and improved production parameters.

According to the invention, production parameters are understood to mean especially the parameters for production of the unshaped products, of the unfired products, of the green bodies, and of the fired ceramic products.

The inventive reactive ceramic binder can be added to the ceramic powder, based on the total weight of the ceramic powder, with a proportion by weight of 0.01 to 70% by weight, preferably of 0.1 to 50% by weight and more preferably of 0.5 to 30% by weight and especially preferably 0.5 to 5% by weight.

It has been found that, surprisingly, the reactive ceramic binder is effective even in much smaller amounts, based on the ceramic powder, than the compounds known from the prior art. Distinct effects can be achieved even with amounts of the alkoxysilyl compounds (1), (5) or (6) of less than 5% by weight, based on the total weight of the ceramic powder.

Preference is given in accordance with the invention to amounts of these alkoxysilyl compounds in the range from 0.05 to <10% by weight, especially 0.1 to 5% by weight, based in each case on the amount of ceramic powder. If the amount of the alkoxysilyl compounds added is below 0.01% by weight, it is very difficult to obtain a fired product with high strength.

According to the invention, the reactive ceramic binder can be used for production of ceramic products, especially of shaped and unshaped, fired and unfired, refractory ceramic products from ceramic powder(s).

The present invention further provides a ceramic composition which comprises inventive ceramic binder and ceramic powder. The ceramic compositions can be used directly or first be processed to powders or granules.

The inventive ceramic compositions can be used for production of shaped and unshaped ceramic products, and for production of fired and unfired ceramic products.

Ceramic powders usable with preference for the production of the ceramic compositions may be selected from the group comprising coarse-grain, mid-grain, fine-grain and/or ultrafine-grain ceramic particles. Suitable ceramic particles may comprise all typical, oxidic, nonoxidic, acidic or basic ceramic raw materials, and mixtures thereof. Particular preference is given to ceramic products based on Al₂O₃. It is also possible for mixtures of these raw materials to be present.

Ceramic powders usable with particular suitability, especially mixtures of ceramic powders and the raw materials thereof, include:

oxides, such as BeO, MgO, Al₂O₃, SiO₂, CaO, TiO₂, Cr₂O₃, MnO, Fe₂O₃, ZnO, ZrO₂, SrO, Y₂O₃, BaO, CeO₂, UO₂; and/or carbides such as B₄C, Be₂C, Be₄C, Al₄C₃, SiC, TiC, Cr₃C₂, Mn₃C, Fe₃C, SrC₂, YC₂, ZrC, NbC, Mo₂C, BaC₂, CeC₂, HfC, TaC, WC, UC, carbon, for example in the form of graphite, carbon black or graphitized carbon material; and/or
nitrides such as Be₃N₂, BN, Mg₃N₂, AlN, Si₃N₄, Ca₃N₂, TiN, VN, CrN, Mn₃N₂, Sr₃N₂, ZrN, NbN, Mo₃N₂, HfN, TaN, WN₂, UN; and/or
borides such as AlB₄, CaB₆, TiB₂, VB₂, CrB₂, MnB, FeB, CoB, NiB, SrB₆, YB₆, ZrB₂, NbB₂, MoB₂, BaB₆, LaB₆, CoB₆, HfB₂, TaB₂, WB, TUB₄; and/or
silicides such as CaSi, Ti₅Si₃, V₅Si₃, CrSi₂, FeSi, CoSi, ZrSi₂, NbSi₂, MoSi₂, TaSi₂, WSi₂; and/or mixtures of the aforementioned ceramic substances.

Further ceramic particles which can be used include oxidic and nonoxidic compounds, mixed phases, etc., for example mullite (Al₆Si₂O₁₃), mixed crystals composed of the Al₂O₃—Cr₂O₃ system, MgSiO₄, CaSiO₄, ZrSiO₄, MgAl₂O₄, CaZrO₃, SIALON, ALON, and/or B₄C—TiB₂.

It is also possible in accordance with the invention to use ceramic particles with nonstoichiometric composition, such as TiOx silicates, glasses and ceramic materials with a metal phase.

Ceramic particles usable in accordance with the invention may also include calcined aluminas, reactive aluminas, ultrafinely ground, refractory raw materials such as microsilica, refractory clay and/or binder clay.

In the context of the present invention, “coarse” is preferably understood to mean particle sizes of 1 mm, more preferably 1 mm to 10 mm. In the context of the present invention, “moderate” is understood to mean particle sizes of 0.1 mm to 1 mm, preferably 0.2 mm to 0.5 mm.

In the context of the present invention, “fine” is preferably understood to mean particle sizes of 0.02 mm to 0.2 mm, more preferably 0.02 mm to 0.1 mm. This particle fraction is typically also referred to in technical language as flour.

Ultrafines are understood to mean especially reactive refractory components with a mean particle size of ≦15 μm, preferably ≦5 μm.

To achieve good strength properties in the inventive ceramic products, it may be advantageous to use ceramic compositions comprising ceramic binders in combination with what are called functional additional components, such as oxidic and/or nonoxidic micro powders, nano powders, metal powders, or fibers and/or fabrics of metal, ceramic, glass or polymer. It is particularly preferred when the ceramic composition comprises nanoscale and/or nanostructured metal oxides, preferably nanoscale and/or nanostructured alumina.

The inventive molding compositions may also be carbon-filled, especially graphite-filled, and in this case may be notable for exceptional lubricant properties. The inventive molding compositions especially have the advantage that, when they are used as channel and/or mold materials, as used, for example, in the steel making industry, adhesion/penetration of liquid iron into/onto the molding compositions is reduced or prevented. Polyethers 1 with a high level of styrene oxide can also excel with particularly advantageous properties in processing to give molding compositions. More particularly, carbon materials, for example carbon blacks or graphites, can be dispersed efficiently into the polyether 1 with a high level of styrene oxide, which leads to advantageous results/properties in the molding compositions.

It has been found to be advantageous for some process steps and/or end uses to at least partly use or additionally use particle sizes below 1 μm, i.e. to add nanoscale and/or nanostructured ceramic powders to the ceramic powder mixture.

The relatively coarse-grain components may be present in the ceramic composition in amounts of 100% by weight, preferably in amounts of 90% by weight, more preferably in amounts of 15% by weight to 80% by weight, based on the total weight of the ceramic composition.

The mid-grain components may be present in the ceramic composition in amounts of 100% by weight, preferably in amounts of 40% by weight, more preferably in amounts of 0% by weight to 20% by weight, based on the total weight of the ceramic composition.

The fine-grain components may be present in the ceramic composition in amounts of 100% by weight, preferably in amounts of 95% by weight, more preferably in amounts of 5% by weight to 80% by weight, based on the total weight of the ceramic composition.

The ultrafine-grain components may be present in the ceramic composition in amounts of 100% by weight, preferably in amounts of 50% by weight, more preferably in amounts of 0.1% by weight to 35% by weight, based on the total weight of the ceramic composition.

The term “total weight of the ceramic composition”, as used above, relates to the ceramic composition without binder.

It is additionally preferred that the ceramic composition is free-flowing. The ceramic composition may have a bulk density of 500 g/l to 10 000 g/l, preferably of 600 g/l to 5000 g/l, more preferably of 700 g/l to 2500 g/l, preferentially of 800 g/l to 1500 g/l and especially preferably of 850 g/l to 1200 g/l.

In addition, it is possible to add to the ceramic composition additives, additional components and/or binders selected from the group comprising organic binders, inorganic binders, water, spreaders, rheology additives, plasticizers, pressing aids and the like.

The inventive ceramic composition may be in the form of an injection molding composition, tamping compound, ramming compound, casting compound, paint composition or coating composition.

The ceramic powder may have particle sizes in the nano range and may preferably consist of oxides, mixed oxides, carbides, nitrides, borides and/or silicides, preferably oxides of aluminum and/or of silicon (for example mullite, spinel).

The resulting ceramic composition can be used directly for the process according to the invention, but it can also be calcined under air, under reduced pressure or in an atmosphere of inert gas, carbon monoxide, carbon dioxide, nitrogen and/or hydrocarbons, and the calcined molding composition can be used in pulverized form and as a ceramic, preferably nanoscale and/or nanostructured, powder.

Particular preference is given to ceramic compositions which comprise ceramic powders, such as magnesium silicates, aluminum silicates, spinels, silicon dioxide, magnesium oxide, calcium oxide, chromium oxide, aluminum oxide, zirconium oxide, zinc oxide, zirconium silicate, silicon carbide, SIALON, ALON, silicon nitride and/or mixtures thereof.

The ceramic compositions may additionally comprise catalysts, customary additional components, binders and/or additives. The ceramic compositions may especially also comprise small amounts of mold release agents, stabilizers and/or pigments.

In addition, it may likewise be advantageous to use ceramic compositions comprising ceramic binders in combination with hydraulic binders, such as alumina cement, portland cement, optionally with water in variable amounts.

The present invention further provides a process for producing ceramic products, especially ceramic refractory materials.

The process according to the invention for production of shaped ceramic products can be divided quite generally into three embodiments.

In the first embodiment, the molding composition, which is a mixture of the ceramic powder and the inventive binder, can first be pressed under a pressure of >1 MPa, preferably between ≧100 MPa and ≦200 MPa, in order to produce a molding blank or green body with a defined outer shape. The pressing can be effected by means of conventional technologies, for example uniaxially, isostatically or the like. The resulting ceramic body can be used without a further thermal treatment or be subjected to subsequent firing to obtain a ceramic product, preferably a refractory ceramic product.

In the second embodiment, the mixture of the ceramic powder and the inventive reactive binder is simultaneously shaped and heated and/or fired (so-called hot-pressing process). This involves pressing the mixture under a pressure of >1 MPa, preferably 5 MPa to 100 MPa, at a temperature higher than room temperature, preferably >50° C. The pressing can be effected by means of conventional technologies, for example uniaxially, isostatically or the like. The resulting ceramic body can be used without further thermal treatment or be subjected to subsequent firing to obtain a ceramic product, preferably a refractory ceramic product.

A suitable process for production of shaped ceramic products, especially shaped refractory ceramic products, comprises the steps below:
a) mixing the inventive reactive ceramic binder with ceramic powder for the purpose of obtaining a molding composition,
b) consolidating the molding composition obtained from step a) by means of pressure treatment and/or thermal treatment to obtain a dimensionally stable ceramic product.

A further process for producing ceramic products, especially refractory ceramic products, comprises the following steps:
a) mixing inventive ceramic binder with ceramic powder;
b) optionally adding additives, assistants and/or additional components and/or other binders;
c) producing a ceramic composition, such as a concrete composition, casting compound, tamping compound or ramming compound.

The reactive ceramic binder comprising at least one compound which has alkoxysilyl groups and is of the formula (1), (5) or (6) may, based on the total weight of the ceramic powder, be present in the molding composition or ceramic composition with a proportion by weight of 0.01% by weight to 70% by weight, preferably of 0.1 to 50% by weight and more preferably of 0.5 to 30% by weight. Components (1), (5) and (6) can be used either individually or in any mixing ratio. Preferably, the inventive binders comprise at least one component of the (5) or (6) type, more preferably of the (5) type. Very particular preference is given to using binder systems composed of alkoxysilane polyethers (1) and/or reactive silicone polyethers of the formula (5).

In order to produce ceramic composite materials, the mixture obtained from step a) of the process can be applied to a dimensionally stable carrier. Subsequently, the ceramic composition can then be dried and/or heat treated and/or fired. The thermal stability and/or size of the carrier material are among the crucial factors for whether the composite material is merely dried or exposed to further thermal treatment steps such as heat treatment and/or firing.

As already described above, it is possible to add to the ceramic powder an additive, additional component and/or binder with a proportion by weight of 0.01 to 50% by weight, preferably of 0.05 to 30% by weight and more preferably of 0.1 to 20% by weight, based on the total weight of the ceramic powder.

The green body obtained from step b) can preferably be consolidated by
drying the green body at a temperature of ≧25° C. to <200° C.; and/or
heat treating it at a temperature of ≧200° C. to <1000° C. and/or
firing it at a temperature of ≧1000° C.

In the production of refractory products, it may also be important that the ceramic binder used in accordance with the invention, comprising alkoxysilyl compounds (1), (5) and/or (6), reacts during the thermal treatment with other constituents of the ceramic composition, preferably of the refractory ceramic composition, to form refractory compounds such as mullite.

In refractory ceramic compositions which form only inadequate strengths, if any, with the liquid alkoxysilane compounds added, sufficient binding power can be achieved by addition of an active ceramic powder. Alumina is particularly suitable here. Also suitable are Al-containing substances which form a reactive alumina after a conversion process, for example oxidation.

The reaction, which is responsible for the binding, between ceramic powder and the polymer bearing alkoxysilyl groups of the inventive reactive ceramic binder may in some cases even take place at room temperature. The binding is consolidated with rising temperature. Even after a thermal treatment in the moderate temperature range, from 400° C. to 1000° C. or in some cases even from 200° C. to 600° C., the ceramic products, especially ceramic refractory materials, can attain high strengths, as a result of which high-temperature firing at >1000° C. is unnecessary.

The strength of the dried and/or heat treated and/or fired molding can also be increased even further by impregnating it at least once with
polymers which bear alkoxysilyl groups and are of the formulae (1), (5), (6) and/or
organomodified siloxane compounds according to EP 1852405 and/or
a liquid polymeric organosilicon compound and/or
with a solution of a solid polymeric organosilicon compound in a solvent and/or
with a melt of a solid polymeric organosilicon compound;
   at room temperature and/or while heating, and heating under air, under reduced pressure and/or in an atmosphere composed of inert gas, hydrogen, carbon monoxide, carbon dioxide, nitrogen and/or hydrocarbons to a temperature of ≧200° C., after the degree of impregnation, if required, has been increased by increasing the pressure.

The addition of a solvent to the ceramic binder to lower the viscosity can promote the impregnating operation. In addition, there exists the option of employing alkoxysilyl compounds of the formulae (1), (5) and (6) free of organic solvents as aqueous emulsions.

A molding blank is understood to mean a usable green body which has a sufficiently high initial strength to be able to be handled or processed by machine in further process steps.

In addition, green bodies can be hardened before the sintering in order thus to obtain even firmer green bodies. The curing can be effected by:
storage in a moist atmosphere and/or
heating to a temperature of 30° C. and/or
addition of suitable condensation catalysts known per se, such as dibutyltin dilaurate, dibutyltin bis(acetylacetonate) or tetrabutyl titanate, acids or bases, and/or
addition of water and/or
use of moist ceramic powders.

The use of the inventive ceramic binders, especially ceramic binders where the reactive ceramic binder comprises alkoxysilyl polymers, can achieve a sufficiently high green strength. The high dimensional stability or cold compressive strength allows the green bodies to be processed further or shaped before the ultimate heat treatment and/or firing operation, without the mechanical stress leading to destruction of the green bodies.

The green bodies can be shaped by customary processes known in the prior art. The shaped green bodies can, if desired, be shaped further by machine processing.

The firing operation of the moldings or of the ceramic products can be continued until no further loss of weight can be observed. The duration of the firing operation can be varied as a function of the temperature, of the composition of the molding composition and of the amount of the alkoxysilyl compounds used in accordance with the invention in the molding composition. Constant weight is typically attained after 1 to 24 hours at temperatures of >400° C.

It has now been found that, surprisingly, in the case of use of the inventive ceramic binders comprising alkoxysilyl polymers of the (1), (5) and/or (6) type, and the inventive molding compositions comprising the reactive liquid ceramic binder, firing of fracture-free ceramic products with outstanding physical and mechanical properties can be achieved:
within a comparatively shorter time at the same firing temperatures; and/or
at comparatively low firing temperatures within comparable times.

The production of shaped ceramic products, such as firebricks, may comprise the following steps:
production of a homogeneous ceramic composition, especially molding composition, from refractory ceramic particles and inventive ceramic binders;
optional addition of a reactive alumina or of an Al-containing substance;
optional addition of water or another binder and homogenization of the ceramic mixture or molding composition;
optional addition of additives and further homogenization of the mixture or molding composition;
optional addition to the mixture of additional components which assume particular functions in the finished bricks. Suitable additional components are, for example, metal powders which improve the oxidation stability of a nonoxidic or only partly oxidic ceramic product, especially of a ceramic refractory material;
pressing of the homogeneous refractory molding composition to give defined brick sizes. Preference is given to pressures of ≧100 MPa and ≦200 MPa;
drying and/or heat treatment of the pressed bricks at temperatures of >50° C.; and/or firing of the dried and/or heat treated bricks at temperatures of ≧400° C.

The production of the unshaped inventive refractory products can be conducted at the refractory manufacturer's premises or on site on the part of the refractory user, preferably in the following steps:
production of a homogeneous ceramic composition;
optional addition of an active alumina or of an Al-containing substance;
optional addition of a binder, additives and/or water and homogenization of the mixture;
optional addition of additional components and further homogenization of the mixture.

If required, additional components which assume particular functions in the finished molding compositions are added to this mixture. Examples of additional components are metal powders and nonoxidic materials such as carbon, carbides, nitrides, silicides, metal fibers, polymer fibers, carbon fibers, which further improve the oxidation stability, strength, drying characteristics, corrosion resistance and/or thermal cycling stability of the ceramic product.

Ceramic compositions, especially homogeneous ceramic compositions, can be processed by means of techniques familiar in refractory technology, such as pressing, casting, vibrating, spraying, guniting, tamping and the like, to give a ceramic product comprising refractory materials, monolithic refractory linings, etc.

It is also possible to produce finished components from the inventive molding compositions, such as refractory molding compositions. For this purpose, the molding compositions produced as described above are introduced into a metal or wood or polymer mold. By subsequent vibration, tamping, pressing, etc., the composition can additionally be consolidated. After curing the composition, the component is demolded and dried and/or heat treated at 30° C. to 400° C. If required, the dried or heat-treated component can be fired. The firing conditions depend essentially on the chemical and mineralogical composition of the refractory composition, and the shape and geometry of the component. In general, firing at temperatures of ≦1800° C. is sufficient. After drying, heat treatment and/or firing, the inventive ceramic finished components, especially refractory materials, may be ready for use.

The degree of curing depends on the shape of the ceramic product. In any case, the ceramic molding is cured to such an extent that it has the strength required to avoid a change in shape during the firing operation.

The inventive shaped and unshaped ceramic products, such as refractory materials, can be used in the furnaces and equipment of the nonferrous metals industry, steel industry, steelmaking industry, cement industry, glass industry, refuse incineration plants, etc.

The present invention further provides the ceramic product, especially dimensionally stable ceramic product, itself.

It has been found in accordance with the invention that, by means of use of the inventive binder, it is possible to produce, from ceramic powder at room temperature or temperatures of <30° C. with action times of several hours or days, ceramic products, especially ceramic compositions, which may be dimensionally stable. Such ceramic products, especially ceramic compositions, may already have a good cold compressive strength.

Particularly preferred ceramic products are refractory ceramic products. The ceramic product may be shaped or unshaped.

Further configurations of the invention are evident from the claims, the disclosure content of which in full is part of this description.

The inventive reactive ceramic binders and the use thereof are described hereinafter by way of example, without any intention that the invention be restricted to these illustrative embodiments.

If ranges, general formulae or compound classes are specified hereinafter, these shall include not only the corresponding ranges or groups of compounds which are mentioned explicitly, but also all sub-ranges and sub-groups of compounds which can be obtained by selecting individual values (ranges) or compounds.

### WORKING EXAMPLES

The examples detailed below describe the present invention by way of example, without any inference that the invention, the range of application of which is evident from the overall description and the claims, can be restricted to the embodiments specified in the examples.

The production and the properties of the inventive products are illustrated below with reference to examples.

In the examples which follow, the following polyethers and silicone polyethers containing trialkoxysilyl groups were used, which have been prepared according to documents DE 10 2008 000360.3 and DE 10 2008 0044373.5, which were yet to be published at the priority date of the present application, by the process principle of DMC-catalyzed alkoxylation of 3-glycidyloxypropyl-triethoxysilane (Dynasylan® GLYEO) from Evonik Degussa GmbH or 3-glycidyloxypropyltrimethoxysilane (Dynasylan® GLYMO) from Evonik Degussa GmbH.

Trialkoxysilyl Polyether 1:

Almost colorless and medium-viscosity polyether of mean molar mass approx. 7000 g/mol and eight-fold trialkoxysilane functionality.

Chemical structure according to monomer dosage: polypropylene glycol monobutyl ether (400 g/mol)+(94 mol of propylene oxide/8 mol of GLYEO, random)

Epoxide oxygen content <0.03%, OH number 7.7 mg KOH/g

Trialkoxysilyl Polyether 2:

Low molecular weight, octanol-started, almost colorless and low-viscosity polyether of blockwise structure with mean molar mass approx. 3000 g/mol and seven-fold trialkoxysilane functionality.

Chemical structure according to monomer dosage: 1-octanol+8 mol of propylene oxide+3.5 mol of GLYEO+8 mol of propylene oxide+3.5 mol of GLYEO+2 mol of propylene oxide

Epoxide oxygen content <0.05%, OH number 19.5 mg KOH/g

Reference Binder 1 (Noninventive)

MS Polymer® SAX 350 from Kaneka, a terminally —Si(CH₃)(OCH₃)₂-functionalized conventional alkoxysilyl-terminated polypropylene glycol with a mean molar mass of approx. 10 000 g/mol

Reference Binder 2 (Noninventive):

MS Polymer® S303H from Kaneka, a terminally —Si(CH₃)(OCH₃)₂-functionalized conventional alkoxysilyl-terminated polypropylene glycol with a mean molar mass of approx. 12 000 g/mol

Reference Binder 3 (Noninventive):

Geniosil® STP-E10 from Wacker, a terminally —Si(CH₃)(OCH₃)₂-functionalized alkoxysilylmethyl carbamate-terminated polypropylene glycol with a mean molar mass of approx. 11 500 g/mol

Reference Binder 4 (Noninventive):

Sulfite liquor comprising calcium bisulfite—an industrial waste product from the paper processing and papermaking industry with variable composition.

General method for use of the ceramic binders in the production of refractory materials:

A high-purity sintered corundum, T60 obtainable from ALMATIS GmbH in Ludwigshafen, with the following particle composition:

| Coarse-grain | 1 to 2 | mm | 50% by wt. |
|---|---|---|---|
| Mid-grain | 0.2 to 0.5 | mm | 10% by wt. |
| Flour | <0.1 | mm | 40% by wt. |

was mixed homogeneously with 4 parts by weight of the particular trialkoxysilyl polyether or reference binder. The mixtures were used to produce cylindrical specimens of diameter 36 mm under a pressure of 100 MPa and then fired at 200° C., 600° C. and 1500° C. for 2 h. After the firing, the specimens had the following characteristics:

TABLE 1

| | Cold compressive strength/MPa | | | |
|---|---|---|---|---|
| | (DIN EN 993-1) | | | |
| | Firing temperature: | | | |
| | 200° C. | 600° C. | 1400° C. | 1600° C. |
| Trialkoxysilyl polyether 1 | 12.0 | n.d. | 76.6 | n.d. |
| Trialkoxysilyl polyether 2 | 18.5 | n.d. | 111.8 | n.d. |
| Reference binder 1: | 1.5 | 0.3 | n.d. | 40.3 |
| Reference binder 2: | 1.4 | 0.3 | n.d. | 41.8 |
| Reference binder 3: | 0.4 | 0.4 | n.d. | 45.4 |
| Reference binder 4: | <5 | <25 | <25 | n.d. |

n.d. = not determined

The addition of the inventive high-functionality alkoxysilyl polyethers brings about a distinct rise in the strength both of the ceramic green bodies and of the finished sintered end products.

1. A curable ceramic binder suitable for production of ceramic products from ceramic powder, characterized in that the reactive ceramic binder comprises hydroxyl compounds bearing silyl groups, alkoxysilyl-functional silicone polyethers or alkoxysilyl-functional polyether-siloxane copolymers.

2. The curable ceramic binder as claimed in claim 1, characterized in that it is liquid.

3. The curable ceramic binder as claimed in claim 1, characterized in that a silyl polyether of the formula 1 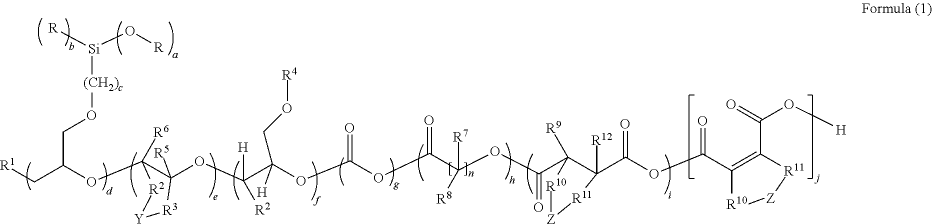
where
a is an integer from 1 to 3,
b is an integer from 0 to 2,
and the sum of a and b is equal to 3,
c is an integer from 0 to 22,
d is an integer from greater than 1 to 1000,
e is an integer from 0 to 10 000,
f is an integer from 0 to 1000,
g is an integer from 0 to 1000,
h, i and j are each integers from 0 to 500,
and with the proviso that the fragments with the indices d to j are freely permutable with one another, i.e. are exchangeable for one another in the sequence within the polyether chain,
n is an integer from 2 to 8 and
R represents one or more identical or different radicals selected from linear or branched, saturated or mono- or polyunsaturated alkyl radicals having 1 to 20 carbon atoms or haloalkyl groups having 1 to 20 carbon atoms, and
R¹ is a saturated or unsaturated, optionally branched radical attached via an oxygen atom, or a polyether radical of the alkoxy, arylalkoxy or alkylarylalkoxy group type in which the carbon chain may be interrupted by oxygen atoms, or an optionally singly or multiply fused aromatic aryloxy group, or a silicon compound or a siloxane radical which may be substituted by alkyl and/or aryl groups,
R² and R³, and R⁵ and R⁶, are the same, or else are each independently, H or a saturated or optionally mono- or polyunsaturated, also further-substituted, optionally mono- or polyvalent hydrocarbon radical, it being the case the R⁵ and R⁶ radicals are each a monovalent hydrocarbon radical, where the hydrocarbon radical might be cycloaliphatically bridged via the Y fragment; Y may be absent, or else may be a methylene bridge having 1 or 2 methylene units; if Y is absent, R² and R³ are each independently a linear or branched radical having 1 to 20 carbon atoms,
R⁴ is a linear or branched alkyl radical of 1 to 24 carbon atoms or an aromatic or cycloaliphatic radical which may optionally in turn bear alkyl groups,
R⁷ and R⁸ are each independently hydrogen, alkyl, alkoxy, aryl or aralkyl groups which are copolymerized with ring-opening polymerization to give crosslinkable polyether esters containing alkoxysilane groups,
R⁹, R¹⁰, R¹¹ and R¹² are each independently hydrogen, alkyl, alkenyl, alkoxy, aryl or aralkyl groups, where the hydrocarbon radical may be bridged cycloaliphatically or aromatically via the Z fragment, and Z may be either a divalent alkylene or alkenylene radical,
is used alone or in a mixture.

4. The ceramic binder as claimed in claim 3, characterized in that it comprises compositions in which the sum of the indices (a) plus (b) in formula (1) has a statistical average of less than 3, since transesterification reactions replace some of the OR groups with silyl polyether groups.

5. The ceramic binder as claimed in claim 3, characterized in that R¹ is a (poly)siloxane radical.

6. The ceramic binder as claimed in claim 5, characterized in that the compound containing a (poly)siloxane radical used is an alkoxysilyl-functional polyether siloxane of the formula (5) and mixtures thereof 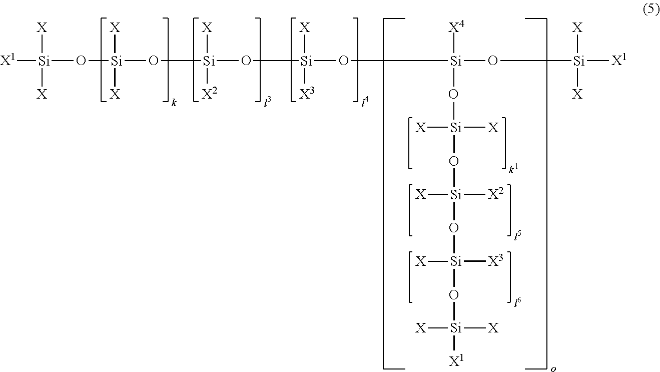
where
X is a linear, cyclic or branched, aliphatic or aromatic, saturated or unsaturated hydrocarbon radical which has 1 to 20 carbon atoms and may contain heteroatoms such as oxygen, nitrogen, phosphorus or sulfur,
X¹ may be X, X² or X³,
X² is an OH-functional polyoxyalkylene radical which bears alkoxysilyl groups and is of the formula (5a), which may be ester- or carbonate-modified, 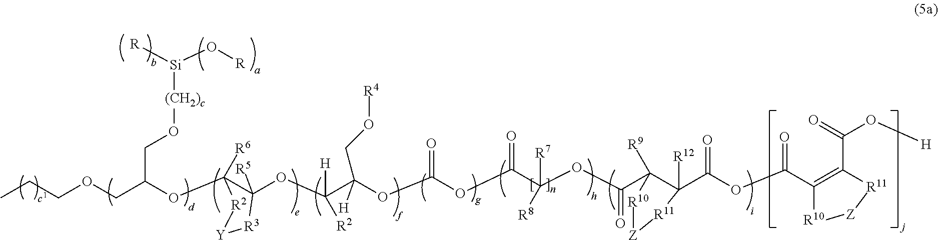
X³ is a terminally etherified polyoxyalkylene radical of the formula (5b) 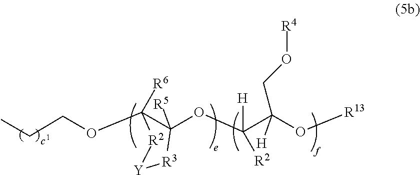
where
R represents one or more identical or different radicals selected from linear or branched, saturated or mono- or polyunsaturated alkyl radicals having 1 to 20 carbon atoms or haloalkyl groups having 1 to 20 carbon atoms,
R² and R³, and R⁵ and R⁶, are the same or different and are each independently H or a saturated or optionally mono- or polyunsaturated, also further-substituted, optionally mono- or polyvalent hydrocarbon radical, it being the case the R⁵ and R⁶ radicals are each a monovalent hydrocarbon radical and the hydrocarbon radical might be cycloaliphatically bridged via the Y fragment; Y may be absent, or else may be a methylene bridge having 1 or 2 methylene units; if Y is 0, R² and R³ are each independently a linear or branched radical having 1 to 20 carbon atoms, and the hydrocarbon radicals R² and R³ may in turn have further substitution and bear functional groups such as halogens, hydroxyl groups or glycidyloxypropyl groups,
R⁴ is a linear or branched alkyl radical of 1 to 18 carbon atoms, which may be bonded to an aromatic or cycloaliphatic radical,
R⁷ and R⁸ are each independently hydrogen, alkyl, alkoxy, aryl or aralkyl groups,
R⁹, R¹⁰, R¹¹ and R¹² are each independently hydrogen, alkyl, alkenyl, alkoxy, aryl or aralkyl groups, where the hydrocarbon radical may be bridged cycloaliphatically or aromatically via the Z fragment, and Z may be either a divalent alkylene or alkenylene radical,
R¹³ is either an alkyl group having 1 to 18 carbon atoms or a polyoxyalkylene radical which has been terminally esterified with a monofunctional carboxylic acid and is of the formula (5c) 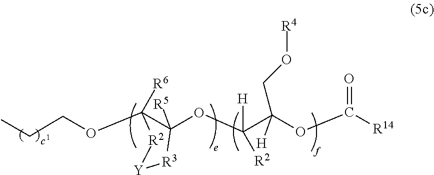
where
R¹⁴ is a saturated or a mono- or polyunsaturated, either linear or branched, aliphatic or aromatic hydrocarbon radical which has 1 to 30 carbon atoms and may in turn bear OH groups,
X⁴ is either X¹ or the fragment of the formula (5d) 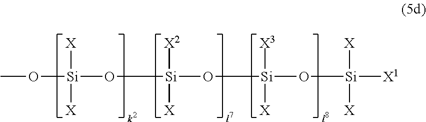
where
k, k¹ and K² are each independently integers from 0 to 500,
l³, l⁴, l⁵, l⁶, l⁷ and l⁸ are each independently integers from 0 to 60,
o is an integer from 0 to 10,
with the proviso that
X¹ is at least once the same as X² if the sum of l³, l⁵ and l⁷ is zero, and that the sum of l³, l⁵ and l⁷ is at least 1 when X¹ is different than X²,
where
a is an integer from 1 to 3,
b is an integer from 0 to 2,
the sum of a and b is equal to 3,
c is an integer from 0 to 22,
c¹ is an integer from 0 to 24,
d is an integer from 1 to 500,
e is an integer from 0 to 5000,
n is an integer from 2 to 8 and
f, g, h, i and j are each integers from 0 to 500,
with the proviso that the fragments with the indices d to j are freely permutable with one another, are exchangeable for one another in the sequence within the polyether chain, and where the different monomer units of the fragments with the indices d to j may each have blockwise structure with respect to one another or else may be subject to a random distribution,
and with the proviso that the fragments with the indices k, k¹, k², l³, l⁴, l⁵, l⁶, l⁷, l⁸ and o are freely permutable with one another, are exchangeable for one another within the siloxane chain and may either be distributed randomly or arranged successively in blocks.

7. The ceramic binder as claimed in claim 1, characterized in that it comprises linear polyether-siloxane-polyether triblock copolymers of the formula (6) in which the polyether chains equipped with alkoxysilyl groups are bonded to the siloxane body via an Si—O—C linkage, b, 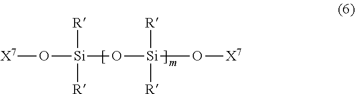
where
R′ is one or more identical or different, linear or branched, saturated or mono- or polyunsaturated alkyl radicals having 1 to 20 carbon atoms, and
m is an integer from 0 to 5000, and
X⁷ is the polyether fragment of the formula (6a) 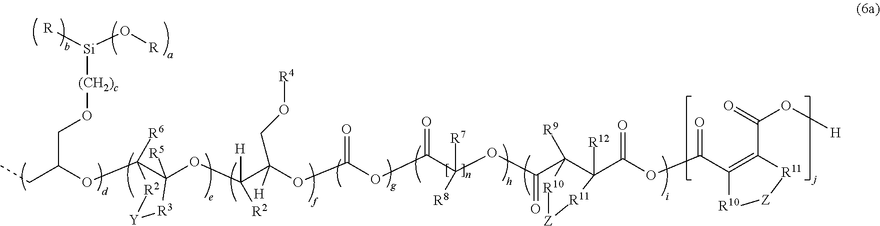
where the substituents R, R²-R¹², the Y and Z radicals and the indices a, b, c, d, e, f, g, h, i, j and n are each as defined above for the compounds of the formula (5a).

8. The ceramic binders as claimed in claim 1, characterized in that they are used alone or in any combination, blended with monomeric alkoxysilanes, alkoxysilyl-terminated prepolymers, alkoxysilyl-modified siloxanes, silicone resins, curing catalysts and further additives, additional components and auxiliaries, which add up to 100 parts.

9. A method of providing a reactive diluents to a reaction mixture which comprises of adding a ceramic binder of claim 1 to a reaction mixture.

10. A method of forming an emulsion which comprises adding a ceramic binder of claim 1 to oil phase and liquid phase.

11. A ceramic composition comprising a ceramic powder and at least one of the ceramic binders as claimed in claim 1.

12. The ceramic composition as claimed in claim 11, comprising at least one ceramic powder based on mixtures of inorganic binders, organic or siloxane compounds bearing alkoxysilyl groups, inorganic salts of sulfuric acid, inorganic salts of hydrochloric acid, inorganic salts of phosphoric acid, magnesium chloride, magnesium sulfate, monoaluminum phosphate, alkali metal phosphate, alkali metal silicate, waterglass, organic binders, cellulose derivatives, polyvinyl alcohol, water, organic solvents, mold release agents, stabilizers, organic pigments, inorganic pigments, nonoxidic substances, carbon, metal powders, metal fibers, ceramic fibers, glass fibers, natural fibers, synthetic fibers, metal oxides, metal hydroxides, mixed oxides, borides, carbides, nitrides, oxynitrides, oxycarbides, silicides, polymers, catalysts and/or carbon fibers, nanoscale and/or nanostructured, oxidic and/or nonoxidic powders, oxidic and nonoxidic ceramic particles, glasses, aluminas, nanoscale and/or nanostructured metal oxides, hydraulic binders, hydratable alumina, calcium aluminate cement, portland cement, gypsum and/or functional additives such as setting retarders, setting accelerators, pressing aids, lubricants, standardizers, defoamers, rheology additives, pressing aids, liquefiers, sintering agents, spreading agents and/or pigments.

13. A shaped and/or unshaped molding composition for production of ceramic products, heat-resistant and/or refractory, unfired and/or fired ceramic moldings, unshaped refractory products, concretes, ramming compounds, casting compounds, coatings and/or overcoats comprising ceramic binders as claimed in claim 1.

14. A ceramic product produced using a ceramic binder as claimed in claim 1.
